(19) United States
(12) Patent Application Publication
(10) Pub. No.: US 2021/0363964 A1
(43) Pub. Date: Nov. 25, 2021

(54) ENERGY COLLECTING SYSTEMS OF THE MARINE, RIVER AND WIND CURRENTS

(71) Applicant: Manuel Munoz Saiz, Almeria (ES)

(72) Inventor: Manuel Munoz Saiz, Almeria (ES)

(21) Appl. No.: 17/360,673

(22) Filed: Jun. 28, 2021

Related U.S. Application Data
(63) Continuation-in-part of application No. 16/324,820, filed on Feb. 11, 2019, now Pat. No. 11,067,055.

(30) Foreign Application Priority Data
Aug. 9, 2016 (ES) P201600696
Feb. 15, 2017 (ES) P201700136
Jun. 23, 2017 (ES) U201700535
Apr. 21, 2021 (ES) U202100176
Jun. 14, 2021 (ES) U202100276

(51) Int. Cl. F03D 3/06; F03B 17/06; F03D 9/25

(52) U.S. Cl. CPC F03D 3/061; F03B 17/061; F05B 2210/16; F05B 2240/97; F03D 9/25

(57) ABSTRACT

The improvements in the energy capture systems of sea, river and wind currents, characterized in that the turbines are helical in shape and the turns or threads have an inclination close to 45°, of a quarter-round or quarter-circle section and are placed together with the shafts of the generators that are covered by a casing. or aerodynamic nacelle in front of or on the other side of the support mast. The upper area of the mast can rotate with the generator and have an aerodynamic profile. They can be installed attached to one end by means of a cable between the two banks of a river, or in a narrowing of the same, or they can be subject to elements or means of fastening consisting of a mast, tree, or with a chain, fixed to the ground. at the bottom of the sea or river. The turbines drive a generator and electrical conduction cables and a security and warning facility are added. The generator is placed between the shaft or end of the turbine and the fastening element or means, or behind the mast, on the opposite side of the turbine. In this case, it carries a ball joint at the upper end of the mast. The mast carries deflector plates that are oriented and direct and increase the flow of water or air towards the turbine.

### INDEX TO RELATED APPLICATIONS

This application is a continuation-in-part of co-pending U.S. patent application Ser. No. 16/324,820 filed Feb. 11, 2019, entitled System For Capturing the Energy of Fluid Currents, which claims benefit of PCT/ES2017/000101, filed Aug. 30, 2017, which claims the benefit of Spanish patent application number U201700535, filed Jun. 23, 2017, Spanish patent application number P201700136, filed Feb. 15, 2017, and Spanish patent application number P201600696, filed Aug. 9, 2016, and Spanish patent application number U202100276, filed Jun. 14, 2021 and Spanish patent application number U202100176 filed Apr. 21, 2021, the disclosures of which are incorporated herein by reference in their entirety.

### FIELD OF THE INVENTION

In energy collectors from sea, river and wind currents, which generate electricity for homes, agriculture, desalination of sea water, rising water, feeding back the current to the electricity grid, obtaining hydrogen by electrolysis of water, etc.

### STATE OF THE ART

Today dams need special locations, large structures and high costs to achieve high yields. The water currents are used with blade turbines, which are not useful because they damage the fauna, all the vegetal elements, algae, garbage, nets, plastics, etc. adhere to them. On the other hand, those of the helical type, or worm screw, are used partially and only enclosed inside ducts, for which they are not efficient. The invention uses improvements for simple, useful and inexpensive axial and helical turbines, protected with patents P201600696, P201700136 and utility model U202100176, which make it possible to take advantage of the energy from wind and sea currents and that available to rivers and streams from its highest area until its arrival at the sea, lake or another river. Generally taking advantage of these, horizontal currents or with little unevenness.

### DESCRIPTION OF THE INVENTION

### Object of the Invention and Advantages

Obtain energy mainly from maritime and river currents, which, unlike solar and wind energy, can or tend to be constant and do not have large periods of calm. Water is about 832 times denser than air. This proportion being higher when it comes to high places where the air is more rarefied.

Being able to use simple, low-cost, high-power, high-performance turbines, minimum cost of kW/h, minimum number of parts, one-piece, without shaft, without bearings, or their supports or supports, anchored to the ground, do not need masts, interlocked , anchored or weighted can be enough, they are clean (they do not affect them or accumulate dirt), they do not need a cover or housing, they admit large and small dimensions, great length or several in series, they can be flexible, inflatable and extensible, they work aligned with the current or inclined with respect to it, they do not kill fish or birds, they protect the ozone layer and the environment, they are self-directing with the current without the use of electrical mechanisms and by using constant currents they eliminate the need to have to store the Energy. The most useful and simple are those that do not have a shaft, twisted metal or plastic beams or planks, and the helical ones of quarter or half-round without a shaft. In all cases, it is of interest that they have a conical or frusto-conical exterior shape with the lower end towards the point of origin of the current.

Provide different fastening systems between turbines and generators and making the masts more aerodynamic.

In 2020, production in Spain was distributed as follows: nuclear (22.2%), wind (21.9%), combined cycle (17.5%), hydraulic (12.2%), cogeneration (10.7%), solar (7.9%) and others (7.8%). These improvements are intended to mainly enhance hydraulic, fluvial or maritime.

### Problem to Solve

Renewable energy is not yet productive enough to use it in large quantities, it is not constant, it produces visual pollution, and due to its discontinuity it needs to be stored. On the other hand, the turbines used in water currents use blades or, when they are helical, they only take advantage of the lateral half of the turbine since they are always used enclosed inside a cylindrical or semi-cylindrical duct. With this system, a lot of and constant energy is obtained, not being necessary its storage, and can be placed where it does not harm or pollute both electrically, audibly and visually and in most rivers whose currents are underused.

Improvements in the energy capture systems of sea, river and wind currents, using simple and efficient turbines and a more aerodynamic arrangement of masts and generators or their cover, in rivers, at sea and in wind systems, are characterized in that the turbines are helical in shape and the turns or threads have an inclination close to 45°, of a quarter-round or quarter-circle section and are placed together with the shafts of the generators that are covered by a casing. or aerodynamic nacelle in front of or on the other side of the support mast. The upper area of the mast can rotate with the generator and have an aerodynamic profile. They can be installed attached to one end by means of a cable between the two banks of a river, or in a narrowing of the same, or they can be subject to elements or means of fastening consisting of a mast, tree, or with a chain, fixed to the ground. at the bottom of the sea or river. The turbines drive a generator and electrical conduction cables and a security and warning facility are added. The generator is placed between the shaft or end of the turbine and the fastening element or means, or behind the mast, on the opposite side of the turbine. In this case, it carries a ball joint at the upper end of the mast.

The helical turbine of the turn or quarter-round thread, or quarter-circle type, has the outermost edge directed towards the current, channeling this and exiting through the opposite edge in the perpendicular direction towards the inside of the turbine.

The turbines are attached to the mast with a ball joint, ring or collar on or around the mast and their connection to the shaft of the electric generator can be with a universal joint or cardan.

Turbines may be shaftless, consisting only of one or two helical fins or turns. The shaft can act as a float.

The turbines have a cylindrical outer shape, and preferably conical or frusto-conical.

On the banks of the rivers, artificial narrowings are made with rocks or concrete blocks and masts in the form of coupling bollards as fastening elements.

When a cable or chain is used, the upper end of the cable or chain carries a buoy or balloon and the other is fixed to the ground or bottom of the sea or lake by means of a ballast or concrete block.

Two or more turbines can be attached to the chain or cable. The turbines can have a density equal to or close to that of water, or they can have different densities, with which they can adopt a certain inclination with respect to the fluid flow.

The turbines, their shafts, fins or turns, in addition to being hollow and filled with air, can be made of plastic polymer foam such as PVC, polyurethane, polyethylene, etc., with a resistant and protective cover, and can act as vanes. The holes can be metal, rubber or plastic, inflatable and flexible. In general, due to being in contact with water and with elements that can be abrasive, resistant and low-density materials, polymers, carbon fibers or glass with resins should be used. And in case of using metallic materials, such as steel, they must have a protective layer of zinc. The plastic can be reinforced with graphene and very resistant synthetic fibers, such as Kevlar, glass, carbon, etc.

The turbine can be fixed to the collar, cardan joint, ball joint, etc. rotatable, and the generator can be positioned in front of or behind the clamping shaft. In this case the shaft of the generator or mechanical device is connected to the rotating end of the turbine directly or by means of an rpm multiplier.

Helical turbines, fins, beams or planks have a performance proportional to their cross or frontal section, the angle they form with the axis of rotation at each point and their length. Angles between 25° and 55° can be used. Unlike turbines of this type that move inside a duct, these can greatly increase their power by increasing their length. The fins can have two types of inclination: a) Inclination of a section of the fin with respect to the axis of rotation and b) Inclination of a section of the fin with respect to a plane perpendicular to the axis of rotation. The maximum yields are produced approximately with angles close to 42° of inclination.

Turbines, when they do not have a shaft, consist exclusively of helical fins or coils, of helical springs of wire or coil, preferably quarter or half-round or flat, or of helically twisted metal or plastic beams or planks. In the fin or helical coil with a quarter-round or quarter-circle section, the air or water when impacting on it is thrown centripetally, generating a reaction with maximum use, for which the efficiency is much higher.

You can use turbines formed by sail surfaces which carry slits through which the air comes out in a lateral and inclined way.

Turbines can be used in series.

Electric generators can be synchronous and totally made of permanent magnets, especially rare earth samarium-cobalt or neodymium-iron-boron.

As mechanical elements, motor pumps are used to lift water or drive electric generators.

The turbines should preferably be axial, receiving the flow of water parallel to their axes and directing themselves automatically as vanes, but they can have an inclination with respect to the horizontal, which depends on the difference between the weight of the turbines, including the adjacent installation, generator, and the weight of the water it displaces. When both factors are equal they remain horizontal in the fluidic stream. Any type of turbine can be used, with or without a shaft, especially those that are prolonged longitudinally and with the blades inclined, twisted or arranged helically. To increase their stability, their profiles are made to be aerodynamic, they have the dimensions of the turbines, their shafts and/or their fins are divergent or of greater dimensions towards the free end.

With the turbines inclined with respect to the flow of the fluid the efficiency can be even greater since the section of the affected surface is much greater than with the frontal current. However, when the turbines receive the current parallel to the axis, as they are not enclosed by a tube, the performance is very high, the power multiplies with the length of the tube. Since downstream the turbine absorbs or laterally captures the energy of the current.

Turbines can have the free end attached to a buoy or float.

Turbines can partially act as floats. In all cases, the turbines, cables, chains, generators or clamping bars can have a density equal to or similar to that of water. They can have a density between 70% and 130% of that of water, although it is not limiting.

The turbines can be arranged neatly, in rows and columns, so that they can use common electrical or water installations and a large surface area.

The fins, blades or turbines can be rigid or flexible. Leaning the flexible fins and reducing their impact surface with increasing water speed.

Small-sized turbines tend to be more revolutionized and do not need revolution multipliers.

The generator is attached to a support point by a rod and a hinge and collar that allows it to tilt slightly vertically and horizontally but not rotate about its axis. This is also achieved with a pair of links or a cardan joint. The generator can also be placed on the other side of the mast from the turbine.

Radial fins help prevent oscillations due to turbulence. A control, warning and security system reports the status of each of the devices.

### BRIEF DESCRIPTION OF THE DRAWINGS

FIG. 1 shows a schematic, partial and lateral view of a turbine of the quarter-round type, or of a quarter-circle section, helical, without shaft, with a frusto-conical shape, a generator and a way of fastening by means of a mast, of the system of the invention.

FIGS. 2 and 3 show plan views of two types of turbine blades of FIG. 1.

FIG. 4 shows a schematic and longitudinally sectioned view of the helical turbine of FIG. 1.

FIGS. 5 to 9 show schematic views and sides of helical turbine variants.

FIG. 10 shows a schematic plan view of the turbine of FIG. 9.

FIG. 11 shows a schematic view of a twisted metal or plastic beam or plank type turbine.

FIGS. 12 and 13 show schematic and plan views of variants of turbines placed by cables between the two banks of a river.

FIG. 14 shows a schematic and perspective view of a way of using a helical-type turbine in the flow of a river.

FIG. 15 shows a schematic and perspective view of a way of using a helical spring type turbine in the flow of a river.

FIG. 16 shows a schematic and perspective view of a way of using several helical spring type turbines in the flow of a river.

FIG. 17 shows a schematic and perspective view of a way of using several helical type turbines in the flow of a river.

FIGS. 18 and 19 show the state of the art. FIG. 18 shows how small jumps are currently used and FIG. 19 shows the turbines used in marine currents.

### MORE DETAILED DESCRIPTION OF AN EMBODIMENT OF THE INVENTION

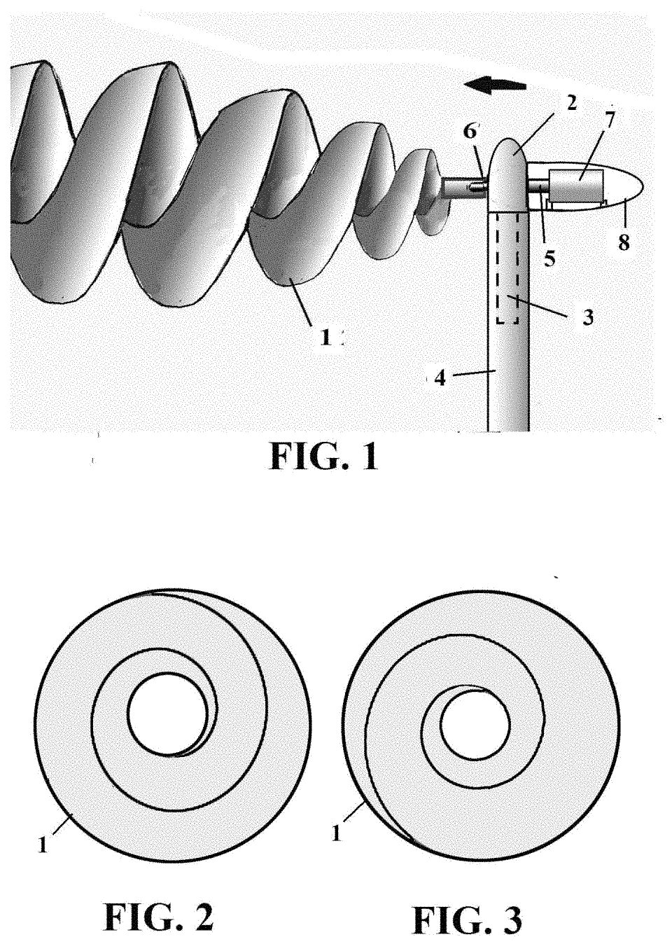

FIG. 1 shows an embodiment of a helical turbine (1), of the quarter-round, or quarter circle type, shaftless, frustoconical in shape, with its lower end (6) attached to the shaft (5) of the electric generator (7) and its cover or nacelle (8) and this in turn forming part of the element aerodynamic support (2) rotatable on the mast (4) by means of the stem (3). Allowing the rotation of the turbine and the axis of the generator and the orientation and inclination of the turbine and the generator. The generator shaft is attached to the support element (2) by one or two bearings. The mast is fixed to the ground at the bottom of the river or the sea.

FIG. 2 shows a turbine (1) of the helical type, without a shaft, with a frusto-conical shape.

FIG. 3 shows a turbine similar to that of FIG. 2 but with different dimensions.

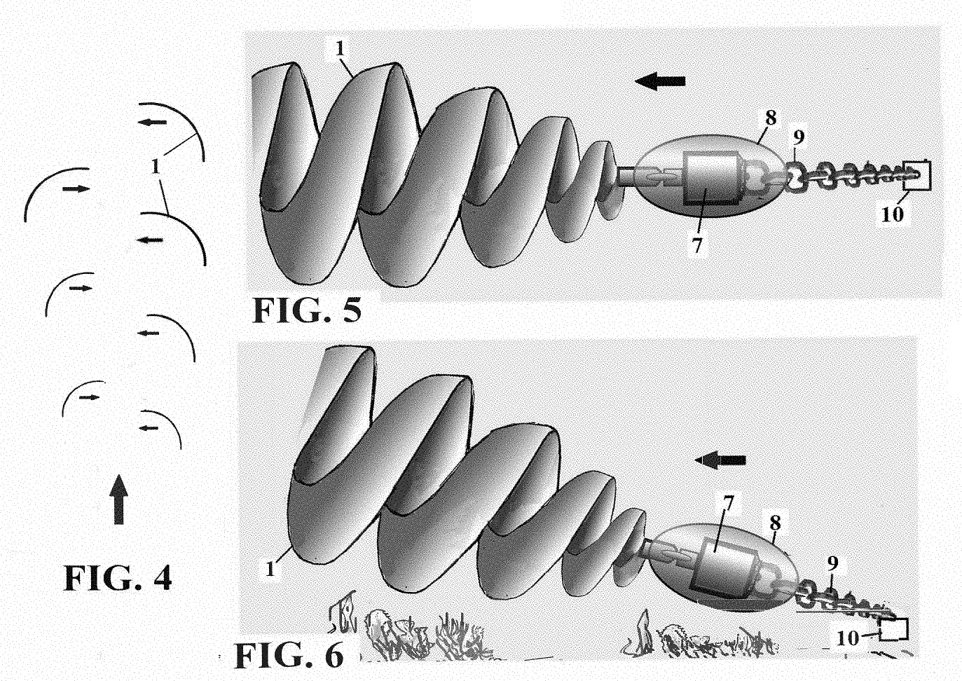

FIG. 4 shows the helical turbine (1) of the quarter-round or quarter-circle type, where the deflection of the water or air in a centripetal manner is shown with the small arrows, generating a reaction and rotation of the turbine.

FIG. 5 shows the helical turbine (1), of the quarter-round or circle type, without shaft, with a frusto-conical shape, the electric generator (7) and its cover or nacelle (8) secured by the chain (9) the which is attached to the bottom of the sea or river by means of the concrete block (10).

FIG. 6 shows the helical turbine (1), of the quarter-round or quarter-circle type, without a shaft, with a frusto-conical shape, the electric generator (7) and its cover or gondola (8) secured by the chain (9) which is attached to the bottom of the sea or river by means of the concrete block (10). It can be anchored to the ground or bottom.

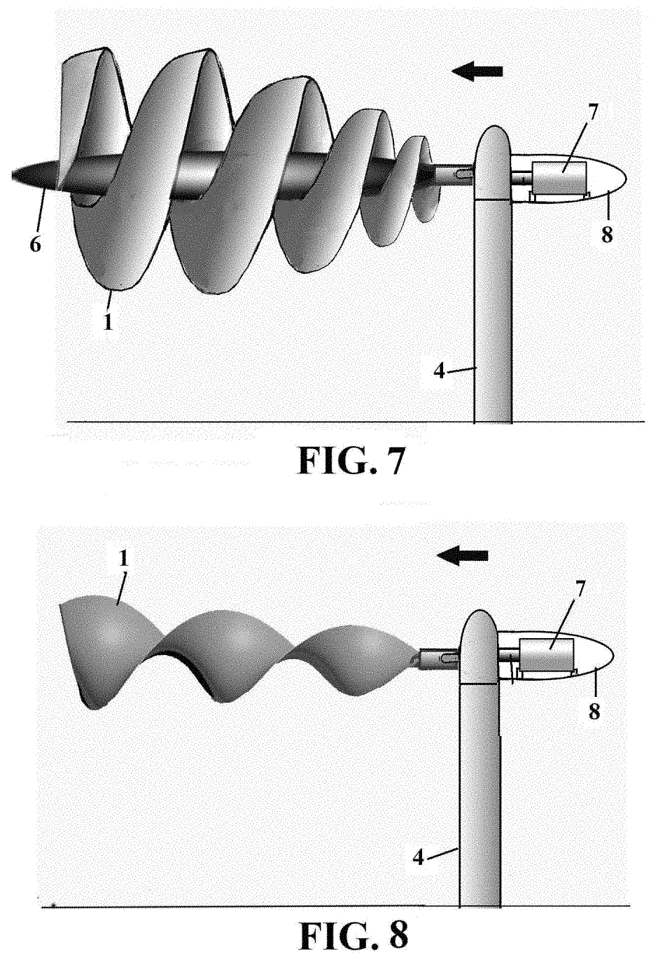

FIG. 7 shows the helical turbine (1), with shaft (6), of the quarter-round or quarter-circle type, with shaft (6), frusto-conical, the electric generator (7) and its cover o nacelle (8) and the mast (4).

FIG. 8 shows the helical turbine (1) with a twisted metal or plastic beam or board, of a frusto-conical shape, the electric generator (7) and its cover or nacelle (8) and the mast (4).

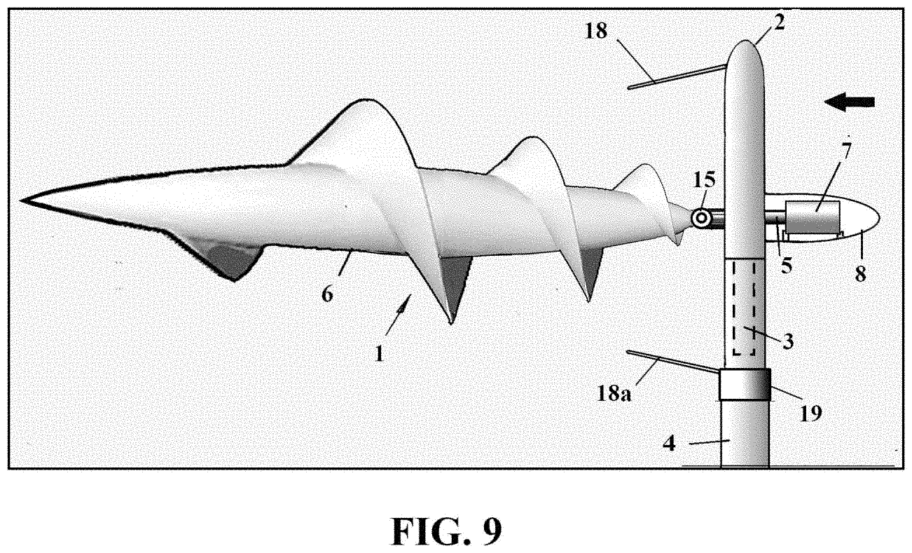

FIG. 9 shows a turbine variant (1) with the shaft (6) and with the cardan joint (15) attached to the shaft of the electric generator (7) and its cover or nacelle (8) and this in turn forming part of the support element (2) rotatable on the mast (4) by means of the stem (3). It allows the rotation of the turbine and the axis of the generator and the orientation and inclination of the turbine and the generator. The generator shaft (5) is attached to the support element (2) with one or two bearings. Add the deflector plates (18) and (18a), the latter attached to the collar (19), which increase the flow of the fluid towards the turbine. The mast is fixed to the ground, the bottom of the river or the sea.

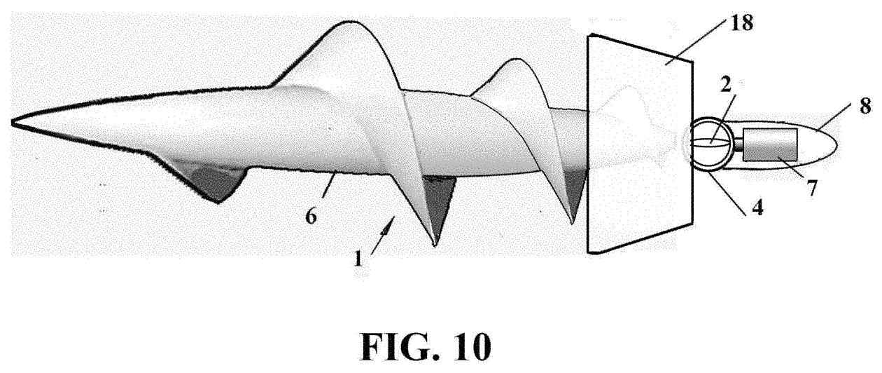

FIG. 10 shows a variant of turbine (1) with shaft (6) attached to the shaft of the electric generator (7) and its cover or nacelle (8) and this in turn forming part of the support element (2) that rotates on the mast (4). The generator shaft is attached to the support element (2) by one or two bearings. Add the baffle plates (18) that increase fluid flow to the turbine. The mast is fixed to the ground, the bottom of the river or the sea.

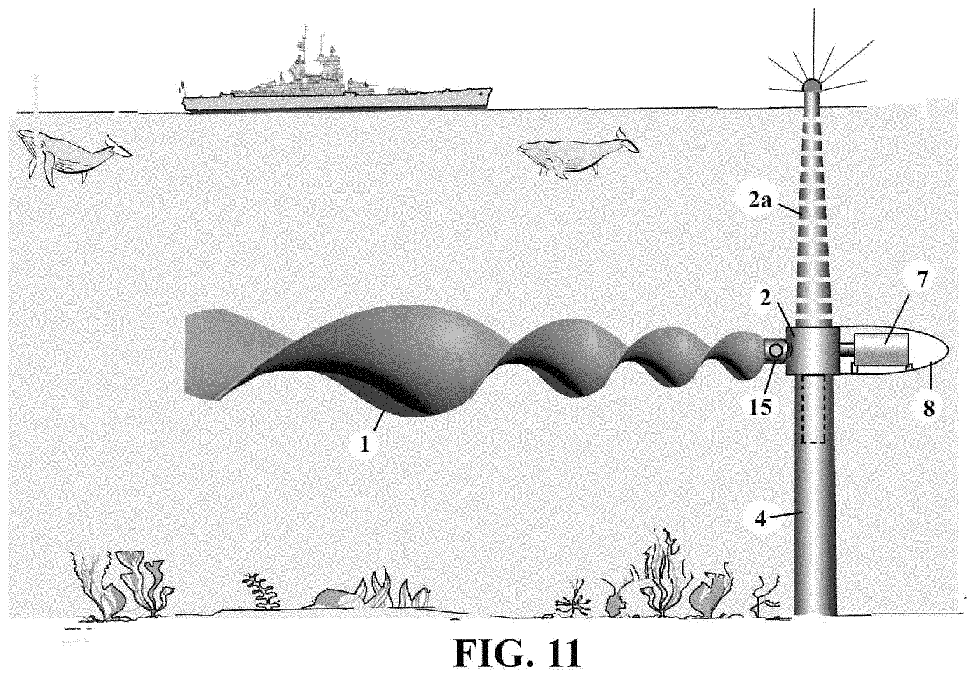

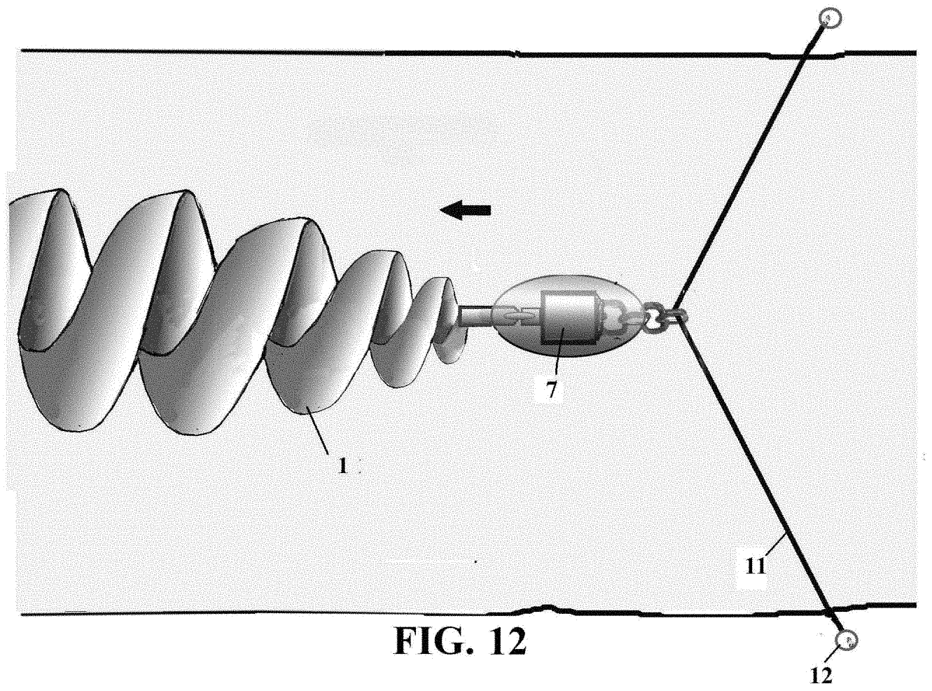

FIG. 11 shows a variant of turbine (1), without a shaft, of the type of metal or plastic twisted beam or plank, the end of which is connected with the cardan joint (15) to the shaft of the electric generator (7) and its cover o nacelle (8) and this in turn forming part of the support element (2) rotatable on the mast (4) by means of the stem (3). Allowing the rotation of the turbine and the axis of the generator and the orientation and inclination of the turbine and the generator. The generator shaft is attached to the support element (2) by one or two bearings. The mast is fixed to the ground, the bottom of the river or the sea. Shows the optional extension (2a) of the bracket (2), with a warning light.

FIG. 12 shows a turbine (1) of the helical type, attached at its end to the cover or nacelle of the generator (7) and this in turn to the cable or chain (11) attached to its ends of the masts in the form of bollards. (12) on the banks of a river.

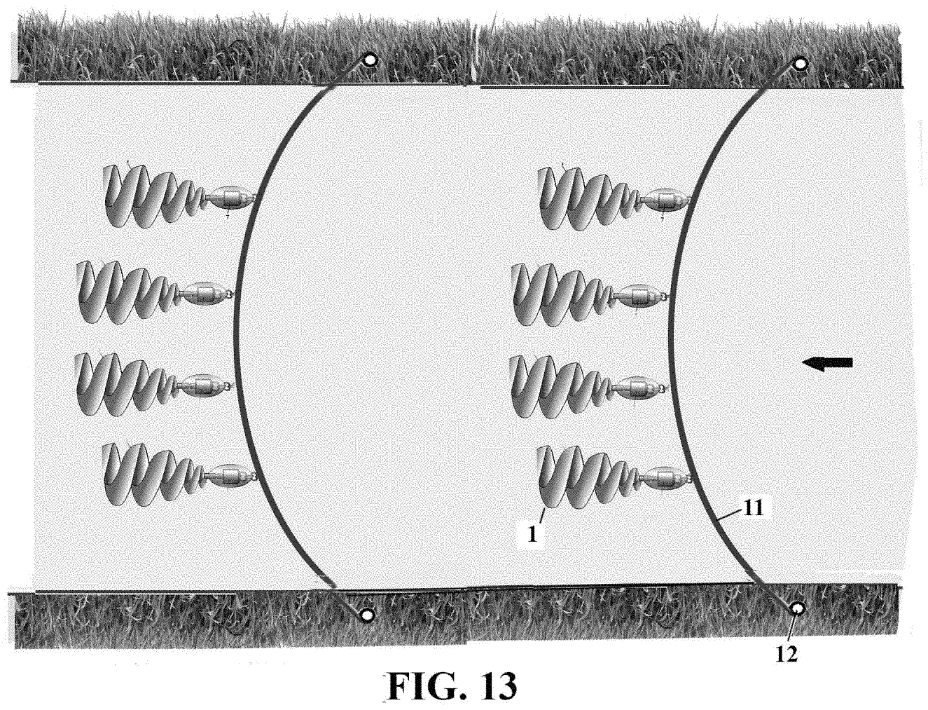

FIG. 13 shows two cables (11) attached to both sides of a river, each one holding rows of generators and their turbines (1). Attached between the masts (12).

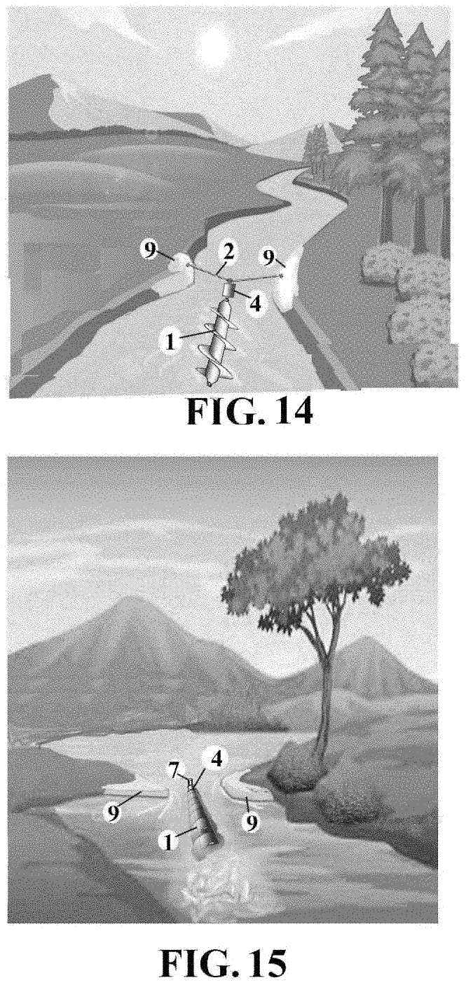

FIG. 14 shows a turbine (1) of the helical type, fastened from its end to the shaft of the electric generator (4) and this in turn fastened with the cable or chain (2) to two small concrete spikes or protrusions (9), narrowers, deflectors and speed increases of the river flow in the area.

FIG. 15 shows a turbine (1) of the helical spring type, semi-submerged, attached from its end to the shaft of the electric generator (4) and this in turn attached to the mast (7) fixed to the bottom of the river. Add the two small concrete breakwaters (9), narrowers, deflectors and speed increases of the river flow in the area.

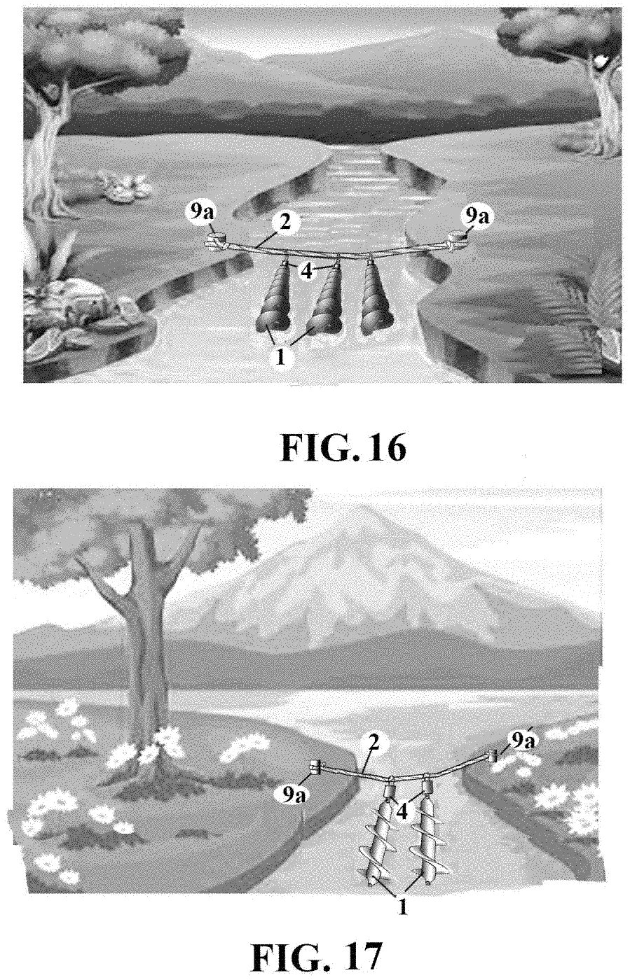

FIG. 16 shows several semi-submerged helical spring type turbines (1), attached at their end to the shaft of electric generators (4) and these in turn attached with the cable or chain (2) to two mooring bollards (9a) on both sides of a narrowing of the river.

FIG. 17 shows several helical type turbines (1), attached at their end to the shaft of some electric generators (4) and these in turn attached with the cable or chain (2) to two mooring bollards (9a) to both sides of a river narrowing.

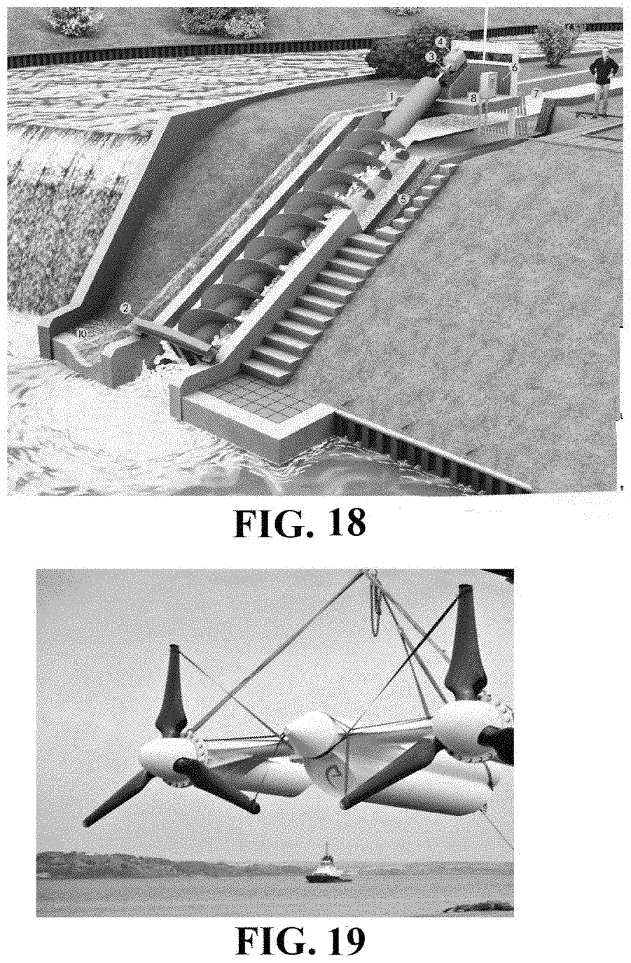

FIG. 18 shows a worm or helical turbine used in a small artificial jump, created to be able to use them in an inclined way. Low performance and expensive system. These turbines with horizontal currents are not used.

FIG. 19 shows the type of turbines used in ocean currents. Which are more effective, but can kill fish and are blunted by sea vegetation, algae, plastics, garbage, etc

1. Improvements in the energy capturing systems of the maritime, fluvial and wind currents, of the type that uses helical turbines, characterized in that the turbines are helical in shape and the turns or threads have an inclination close to 45°, and are fastened of one end by means of a cable between the two banks of a river, or in a narrowing of the same, or they are fastened to a mast, tree or a chain, fixed to the ground or to the bottom of the sea, attached to the shafts of the generators that are covered by an aerodynamic casing or nacelle, in front of or, on the other side of the supporting mast, the turbines drive a generator and electrical conduction cables and a safety and warning installation are added, the generator is placed between the shaft or end of the turbine and the fastening element or means, or behind the mast, on the opposite side of the turbine.

2. Improvements according to claim 1, wherein the upper end of the mast carries a generator support element, which has an aerodynamic profile and rotates with respect to the mast by means of a rod that is inserted into said mast.

3. Improvements according to claim 1, wherein the turbines are fastened with a ball joint, ring or collar around the mast and their connection to the axis of the electric generator is made with a universal joint or cardan.

4. Improvements according to claim 1, wherein the helical turbines are of a quarter-round or quarter-circle thread type, have the outermost edge directed towards the current, this channeling the fluid towards the opposite edge in the direction perpendicular, towards the inside of the turbine.

5. Improvements according to claim 1, wherein the turbines adopt a cylindrical, conical or frusto-conical external shape.

6. Improvements according to claim 1, wherein artificial narrowings are made on the banks of the rivers with rocks or concrete blocks and posts in the form of coupling bollards as fastening elements.

7. Improvements according to claim 1, wherein a cable or chain is used, the upper end of the cable or chain carries a buoy or balloon and the other is fixed to the ground or bottom of the sea or river by means of a ballast anchor or block of concrete.

8. Improvements according to claim 1, wherein the turbines, their shafts, fins or turns, in addition to being hollow, are filled with air or plastic polymer foam such as PVC, polyurethane and polyethylene, with a resistant and protective cover.

9. Improvements according to claim 1, wherein the turbines, in addition to being hollow, are metallic, rubber or plastic, inflatable or flexible and resistant and low-density materials are used, polymers, carbon fibers or glass with resins, and when they are made of Steel has a protective layer of zinc and plastic is reinforced with graphene and strong synthetic fibers, kevlar, glass or carbon.

10. Improvements according to claim 1, wherein the turbines are fixed to the collar, cardan joint or ball joint and the generator is positioned in front of or behind the clamping mast, in which case the generator shaft or mechanical device is connected to the rotating end of the turbine directly or via an rpm multiplier.

11. Improvements according to claim 1, wherein the turbines, when they do not have a shaft, consist exclusively of helical fins or turns, of helical springs of wire or spiral preferably of quarter or half-round or flat, or of metal beams or planks or of plastic twisted helically.

12. Improvements according to claim 1, wherein the turbines are used in series.

13. Improvements according to claim 1, wherein the electric generators are synchronous, and entirely made of permanent magnets. samarium-cobalt or neodymium-iron-boron.

14. Improvements according to claim 1, wherein the turbines have the free end attached to a buoy, float or balloon.

15. Improvements according to claim 1, wherein the turbines, cables, chains, generators or clamping bars have a density equal to or similar to that of water or air, between 70% and 130% of that of water or air. air.

16. Improvements according to claim 1, wherein the fins, blades or turbines are flexible, the flexible fins inclining and reducing their impact surface with increasing water speed.

17. Improvements according to claim 1, wherein the turbines use a revolution multiplier between them and the generator.

18. Improvements according to claim 1, wherein a control, warning and security system reports the status of each of the devices.

19. Improvements according to claim 1, wherein the mast carries deflector plates that are oriented and direct and increase the flow of water or air towards the turbine.

20. Improvements according to claim 1, wherein helical turbines are placed between the two banks of a river, or in a narrowing thereof, said turbines held at one end by means of elements or means of fastening consisting of a mast or a chain, fixed to the bottom, or to a cable or chain placed between the two banks of the river or its narrowing
